(19) United States
(12) Patent Application Publication
(10) Pub. No.: US 2010/0094608 A1
(43) Pub. Date: Apr. 15, 2010

(54) METHOD OF PROCESSING RIGID BODY INTERACTION IN PARTICLE-BASED FLUID SIMULATION

(75) Inventors: Seung Taik Oh, Daejeon (KR); Young Hee Kim, Daejeon (KR); Byung Seok Roh, Daejeon (KR); Bon Ki Koo, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/481,305

(22) Filed: Jun. 9, 2009

(30) Foreign Application Priority Data
Oct. 14, 2008 (KR) 10-2008-0100735

(51) Int. Cl. G06G 7/48

(52) U.S. Cl. 703/9

(57) ABSTRACT

A method of processing a rigid body interaction in a particle-based fluid simulation includes determining a collision direction based on a normal vector of a pair of input particles and confirming whether parent objects of the particles actually collide against each other after the determination, and calculating a perpendicular impulse based on properties of the parent objects when the collision is confirmed. The method further includes calculating a final collision based boundary force by applying a tangential friction force to the calculated perpendicular impulse to apply the final collision based boundary force to the respective particles.

### CROSS-REFERENCE(S) TO RELATED APPLICATION(S)

The present invention claims priority of Korean Patent Application No. 10-2008-0100735, filed on Oct. 14, 2008, which is incorporated herein by reference.

### FIELD OF THE INVENTION

The present invention relates to a particle-based fluid simulation and, more particularly, to a method of processing an interaction of a fluid with a rigid body in a particle-based fluid simulation which simulates natural phenomena by expressing an object in the form of particles.

### BACKGROUND OF THE INVENTION

In a fluid simulation, one or more rigid body is usually included and it is very important factor to process an interaction between the fluid and the rigid body.

In an existing particle-based fluid simulation, Monaghan has introduced a repulsive force of preventing a fluid from penetrating a rigid body as a scheme of processing an interaction of the fluid with the rigid body, based on Lennard-Jones potential, a model of a force between molecules. This repulsive force is referred to as a boundary force, particularly, the boundary force introduced by Monaghan is referred to as a Monaghan boundary force (hereinafter, referred to as “MBF”).

Currently, the MBF scheme is widely used in processing interactions between the fluid and rigid body in a smoothed particle hydrodynamics (SPH), a typical method of simulating a fluid as particles.

The MBF scheme is easily implemented and widely applicable regardless of a type of objects.

The existing MBF scheme can sufficiently cover the prevention of penetration of particles but cannot sufficiently express dynamic properties of a rigid body during collision.

Since the MBF scheme is introduced to prevent particles with a maximum speed that is set in the SPH from penetrating a rigid body, the MBF depends only on a distance from the rigid body is calculated. Drawbacks of the MBF hardly occur in a simulation of interaction between a fluid and a rigid body, but it is very difficult to obtain a plausible result in a simulation in which rigid bodies collide with each other. Particularly, since a term, 1/y goes to infinite when a distance to a rigid body goes to zero, resulting in producing too large force, this term becomes a latent unstable factor in the simulation.

### SUMMARY OF THE INVENTION

It is, therefore, an object of the present invention to provide a method of stably and precisely processing (calculating) interaction associated with a rigid body (hereinafter, referred to as “rigid body interaction”) such as interaction between a fluid and a rigid body and between rigid bodies.

To this end, in the present invention, an impulse generated by a collision between rigid bodies is employed to calculate a new boundary force. The new boundary force is advantageous in that the impulse is precisely calculated so that the movement after collision with the rigid body can be simulated realistically and a highly precise simulation only between rigid bodes is enabled. In the present invention, this new boundary force is referred to as a collision-based boundary force (CBF).

In accordance with an embodiment of the invention, there is provided a method of processing a rigid body interaction in a particle-based fluid simulation includes determining a collision direction based on a normal vector of a pair of input particles and confirming whether parent objects of the particles actually collide against each other after the determination, and calculating a perpendicular impulse based on properties of the parent objects when the collision is confirmed. The method further includes calculating a final collision based boundary force by applying a tangential friction force to the calculated perpendicular impulse to apply the final collision based boundary force to the respective particles.

Preferably, in the determination of the collision direction, the collision direction is determined according to a fluid-rigid body case and a rigid body-rigid body case.

Further, in the determination of the collision direction, when a normal vector of a rigid body particle is determined as a vertex normal vector of a polygon mesh, the normal vector of the rigid body particle may be selected as the collision direction in the fluid-rigid body case.

Moreover, in the determination of the collision direction, when particles positioned at positions other than corners on the rigid body are referred to as regular particles, the collision direction in the rigid body-rigid body case may be selected according to a regular particle-regular particle mode, a corner particle-corner particle mode, and a regular particle-corner particle mode.

It is preferred that any one of normals of regular particles is selected as the collision direction in the regular particle-regular particle mode, any one of normals of the corner particle-corner particle mode is selected as the collision direction such that one normal vector of pairs of colliding rigid bodies is consistently selected as the collision direction for the consistency, and a normal of the regular particle is selected as the collision direction in the regular particle-corner particle mode.

Preferably, in the calculation of the perpendicular impulse, the perpendicular impulse is calculated when the particles satisfy a preset collision condition.

The calculation of the perpendicular impulse may be performed with respect to variables containing the collision direction, relative velocities of the particles, mass of fluid particle, and mass and rotational inertia of the rigid body, considering the fluid-rigid body case as a collision between a point mass and a rigid body in the fluid-rigid body case.

Further, the calculation of the perpendicular impulse may be performed with respect to variables containing the collision direction, relative velocities of the particles, and masses and rotational inertias of the rigid bodies, considering the rigid body-rigid body case as a collision between the rigid bodies at several points thereof.

It is preferred that, in the application of the final collision based boundary force to the respective particles, the tangential friction force, represented as a damping, is added to the perpendicular impulse.

Further, in the application of the final collision based boundary force to the respective particles, the impulse boundary force may be calculated by taking scaling factors with respect to the perpendicular direction and tangential direction that are used in Monaghan boundary force and the tangential friction force into consideration.

The present invention is advantageous as follows:

First, the existing Monaghan boundary force is not suitable for the rigid body-rigid body interaction, but both of the interactions between a fluid and a rigid body and between rigid bodies can be expressed by a single boundary force when using the collision based boundary force of the present invention.

Second, since the term “1/y” existing in the Monaghan boundary force is not present in the collision based boundary force of the present invention, more stable simulation can be achieved.

Third, in the collision based boundary force according to the present invention since the impulse is precisely calculated during the interaction, particularly, between rigid bodies and then the result is reflected on the boundary force, a stable and precise particle-based rigid body simulation is enabled in a case of simulating only rigid bodies without the fluid.

### BRIEF DESCRIPTION OF THE DRAWINGS

The above and other objects and features of the present invention will become apparent from the following description of embodiments given in conjunction with the accompanying drawings, in which:

FIG. 1 is a block diagram illustrating an apparatus for processing interaction with a rigid in a particle-based fluid simulation according to an embodiment of the present invention;

FIG. 2 is a flowchart illustrating a method of processing interaction with a rigid body performed by the apparatus for processing interaction with a rigid body according to an embodiment of the present invention; and

FIGS. 3A to 3C are a view illustrating a determination of a collision direction between rigid bodies by the method of processing interaction with a rigid body according to the embodiment of the present invention.

### DETAILED DESCRIPTION OF THE EMBODIMENTS

Hereinafter, embodiments of the present invention will be described in detail with reference to the accompanying drawings. In the following description of the present invention, if the detailed description of the already known structure and operation may confuse the subject matter of the present invention, the detailed description thereof will be omitted.

First, for the appreciation of the present invention, terms used in the following description will be defined.

particle simulation: simulating natural phenomena by expressing an object in the form of particles

smoothed particle hydrodynamics (SPH): a typical method of simulating a fluid as particles

impulse: a force generated by collision between rigid bodies. Forces of same magnitude and opposite direction are applied to two bodies, respectively, according to the principle of action and reaction.

rigid body interaction: an expression meaning an interaction with rigid bodies and in the present invention means an interaction between a fluid and a rigid body and between rigid bodies.

boundary force: a repulsive force acting on a rigid body around the periphery thereof used for handling an interaction between a rigid body and other object in the SPH.

smoothing length: a value in which a preset factor is multiplied to the particle spacing in the SPH simulation. When the particle spacing is set to ‘d’, a smoothing length h is determined as 1.2 times d.

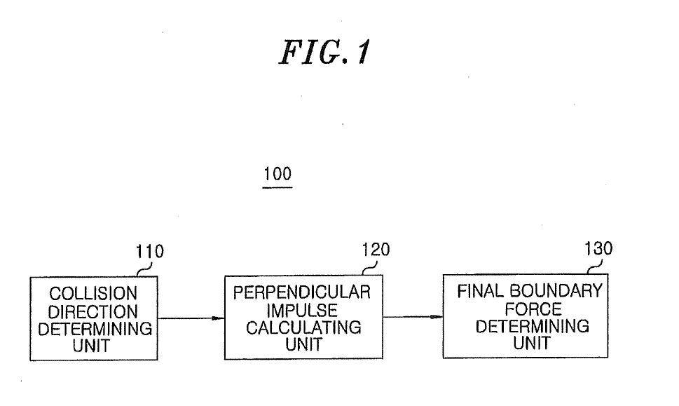

FIG. 1 is a block diagram illustrating an apparatus for processing interaction with a rigid in a particle-based fluid simulation according to an embodiment of the present invention.

A rigid body interaction processing apparatus 100 receives two particles sufficiently close to each other and applies a collision based boundary force (CBF) to parent objects (fluid particles or rigid bodies) to which the two particles belong. When a distance between the two particles is equal to or less than 2h (h is a smoothing length), it is expressed by “sufficiently close.”

The rigid body interaction processing apparatus 100 includes a collision direction determining unit 110 finding a normal vector of determining a collision direction and then determining a collision direction based on the normal vector; a perpendicular impulse calculating unit 120 checking whether the parent objects actually collide with each other based on the collision direction determined by the collision direction determining unit 110, when the collision is confirmed, and then calculating a perpendicular impulse based on properties of the parent objects; and a final boundary force determining unit 130 applying a tangential frictional force to the perpendicular impulse calculated by the perpendicular impulse calculating unit 120 to calculate a final collision based boundary force and then applying the final collision boundary force to the respective particles.

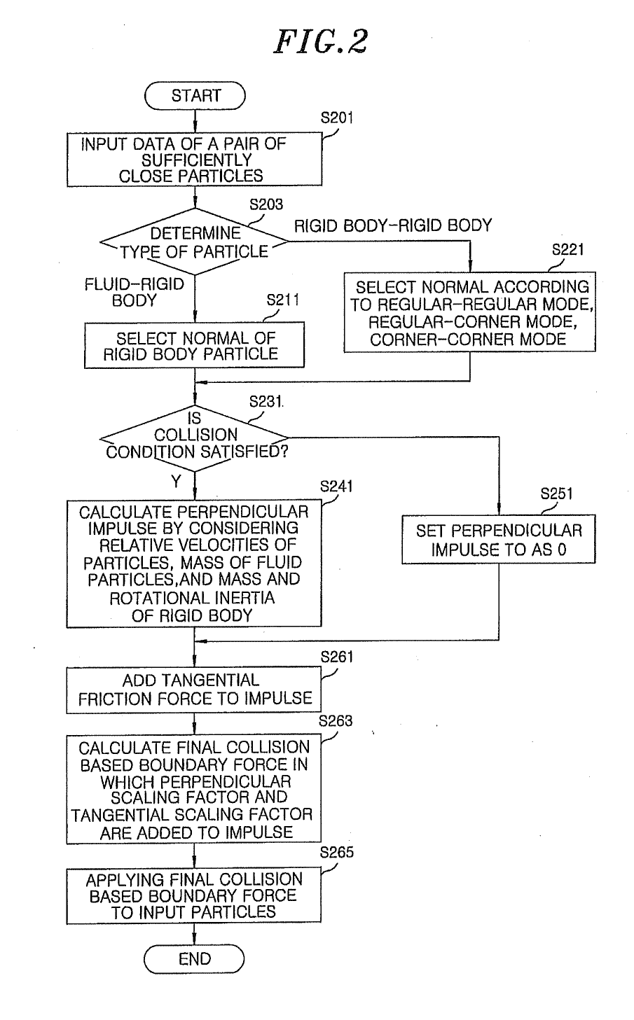

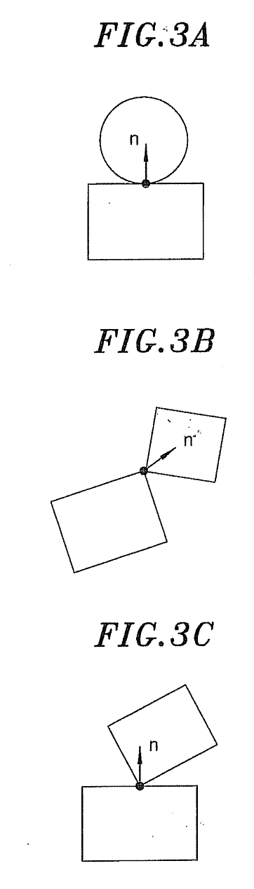

A rigid body interaction processing method performed by the rigid body interaction processing apparatus 100 will be described with reference to FIGS. 2 and 3. Hereinafter, for the clear appreciation, it is assumed that two particles A and B have entered the collision direction determining unit 110 as an input data (S201).

First, the collision direction determining unit 110 determines types of particles for the determination of the collision direction by classifying the input data into a fluid-rigid body case and a rigid body-rigid body case (S203).

It is assumed that a normal vector of a rigid body particle is a normal of a vertex of a polygon mesh. A collision direction of a fluid-rigid body case is obtained by selecting the normal vector of a rigid particle (S211).

In a rigid body-rigid body case, a collision direction is determined by obtaining a normal vector in the following three modes.

When a particle at a position other than corners on a rigid body is referred to as a regular particle, one of normal vectors of the regular particles is selected as a collision direction in a regular particle-regular particle mode as illustrated in FIG. 3A. One of normal vectors is selected as a collision direction in a corner particle-corner particle mode as illustrated in FIG. 3B. However, for the consistency, one normal vector of ordered pairs of colliding rigid bodies may be consistently selected as a collision direction, or a normal vector may be selected as a collision direction by referring to preset index of the rigid bodies, the index showing which rigid bodies are selected as a collision normal. In a regular particle-corner particle as illustrated in FIG. 3C, a normal vector of the regular particle is selected as a collision direction (S221).

Next, after the collision direction is determined by the collision direction determining unit 110, the perpendicular impulse calculating unit 120 calculates a perpendicular impulse boundary force when a condition of collision is satisfied, i.e., the rigid bodies approach each other (S231).

The condition of collision is expressed by the following equation 1:

(v_{A}−v_{B})·n<0 (Eq. 1)

where v_{A} is a velocity of a particle A, v_{B} is a velocity of a particle B, and n is a collision normal.

In general, for a collision generated by an impulse applied between rigid bodies, a relative velocity after the collision is determined by a coefficient of restitution of the rigid bodies. In the present invention, it should be understood that a fluid-rigid body case is a collision between a point mass and a rigid body, and that the rigid body-rigid body case is a collision between rigid bodies at several points thereof. When a direction of the impulse is assumed as a normal of a particle B, the impulse J=jn (n: normal) is determined as follows.

First, in the fluid-rigid body case, since a rotational inertia of the fluid particle can be assumed infinite, the impulse is determined by the following equation 2 (S241).

$$j = \frac{- ( 1 + e ) {v}_{AB} \cdot n}{{m}_{A}^{- 1} + {M}_{B}^{- 1} + ( {I}_{B}^{- 1} ( {r}_{B} \times n ) \times {r}_{B} ) \cdot n} \qquad ( Eq . 2 )$$

Next, in the rigid body-rigid body case, the impulse is determined by the following equation 3 (S241).

$$j = \frac{- ( 1 + e ) {v}_{AB} \cdot n}{{\sum }_{i = \{ A , B \}}^{ } ( {M}_{i}^{- 1} + ( {I}_{i}^{- 1} ( {r}_{i} \times n ) \times {r}_{i} ) \cdot n )} \qquad ( Eq . 3 )$$

In the equations 2 and 3, v_{AB} is a relative velocity of the particle A with respect to the particle B, m_{A} is a mass of the fluid particle, M_{A} and M_{B} are masses of the rigid bodies, I_{A} and I_{B} are rotational inertias of the rigid bodies, r_{A} and r_{B} are relative positions with respect to centers of mass of the particles A and B, e is the coefficient of restitution, and n is a collision normal.

Finally, the final boundary force determining unit 130 adds a tangential frictional force, which can be represented as damping, to the impulse calculated by the perpendicular impulse calculating unit 120. The tangential frictional force (F_{fric}) is expressed by the following equation 4:

F_{fric}=−μ(v_{AB}−(v_{AB}·n)n), (Eq. 4)

where μ is a damping coefficient, v_{AB} is v_{A}−v_{B}, and n is a collision normal.

Based on the collision normal n, it is assumed that a tangential coordinate of the particle A with respect to the surface of the particle B is x, a perpendicular coordinate of the particle A is y, a current time step of the simulation is Δt, and a smoothing length of the simulation is h.

Then, a final collision based boundary force F_{CBF} applied to the particle A is determined by the following equation 5:

$${F}_{CBF} = Γ ( y ) χ ( x ) \tilde{F} \\ where , \tilde{F} = \{ \begin{matrix}J / Δ t + {F}_{fric} \text{:} & if equation 1 holds \\ {F}_{fric} \text{:} & otherwise\end{matrix} \} \\ Γ ( y ) = \{ \begin{matrix}\frac{2}{3} \text{:} & 0 < q < \frac{2}{3} \\ 2 q - \frac{3}{2} {q}^{2} \text{:} & \frac{2}{3} < q < 1 \\ \frac{1}{2} {( 2 - q )}^{2} \text{:} & 1 < q < 2 \\ 0 \text{:} & otherwise\end{matrix} \\ ( where , q = y / h ) \\ χ ( x ) = \{ \begin{matrix}1 - x / Δ \text{:} & 0 < x < Δ p \\ 0 \text{:} & otherwise\end{matrix} \qquad ( Eq . 5 )$$

where Γ(y) and χ(x) are respective scaling factors with respect to the perpendicular and tangential directions used in the MBF scheme.

To sum up the process of calculating the final collision based boundary force with the equations 4 and 5 by the final boundary force determining unit 130, firstly whether the particles satisfy the preset collision condition defined by the equation 1 (S231) is memorized, an intermediate boundary force \tilde{F} is calculated by taking a perpendicular impulse, a current time step of the simulation, and the tangential friction force into consideration when the collision condition is satisfied (S261). When the collision condition is not satisfied, the intermediate boundary force is determined by only the tangential friction force (S251 and S261).

Moreover, the final collision based boundary force F_{CBF} is calculated by taking the scaling factors in the perpendicular and tangential directions used in the MBF scheme into consideration (S263), and the calculated final collision based boundary force is applied to the particles to process an interactive operation between the particles (S265).

The method of processing an interaction with a rigid body according to the present invention can be implemented by a computer program. Codes and segments of the codes that constitute the computer program can be easily derived by a computer programmer in this art. Moreover, the computer program is stored in a computer readable media and read and executed by a computer to achieve the method of processing an interaction with a rigid body. The computer readable media includes a magnetic recording media, an optical recording media, a carrier wave media, and the like.

While the invention has been shown and described with respect to the preferred embodiments, it will be understood by those skilled in the art that various changes and modifications may be made without departing from the spirit and scope of the invention as defined in the following claims.

What is claimed is:

1. A method of processing a rigid body interaction in a particle-based fluid simulation, comprising:
determining a collision direction based on a normal vector of a pair of input particles;
confirming whether parent objects of the particles actually collide against each other after the determination, and calculating a perpendicular impulse based on properties of the parent objects when the collision is confirmed; and
calculating a final collision based boundary force by applying a tangential friction force to the calculated perpendicular impulse to apply the final collision based boundary force to the respective particles.

2. The method of claim 1, wherein, in the determination of the collision direction, the collision direction is determined according to a fluid-rigid body case and a rigid body-rigid body case.

3. The method of claim 2, wherein, in the determination of the collision direction, when a normal vector of a rigid body particle is determined as a vertex normal vector of a polygon mesh, the normal vector of the particle is selected as the collision direction in the fluid-rigid body case.

4. The method of claim 2, wherein, in the determination of the collision direction, when particles positioned at positions other than corners on the rigid body are referred to as regular particles, the collision direction in the rigid body-rigid body case is selected according to a regular particle-regular particle mode, a corner particle-corner particle mode, and a regular particle-corner particle mode.

5. The method of claim 4, wherein any one of normals of regular particles is selected as the collision direction in the regular particle-regular particle mode, any one of normals of the corner particle-corner particle mode is selected as the collision direction such that one normal vector of ordered pairs of colliding rigid bodies is consistently selected as the collision direction for the consistency, and a normal of the regular particle is selected as the collision direction in the regular particle-corner particle mode.

6. The method of claim 1, wherein, in the calculation of the perpendicular impulse, the perpendicular impulse is calculated when the particles satisfy a preset collision condition.

7. The method of claim 1, wherein, the calculation of the perpendicular impulse is performed with respect to variables containing the collision direction, relative velocities of the particles, mass of fluid particle, and mass and rotational inertia of the rigid body, considering the fluid-rigid body case as a collision between a point mass and a rigid body in the fluid-rigid body case.

8. The method of claim 1, wherein, the calculation of the perpendicular impulse is performed with respect to variables containing the collision direction, relative velocities of the particles, and masses and rotational inertias of the rigid bodies, considering the rigid body-rigid body case as a collision between the rigid bodies at several points thereof.

9. The method of claim 1, wherein, in the application of the final collision based boundary force to the respective particles, the perpendicular friction force, represented as a damping, is added to the perpendicular impulse.

10. The method of claim 1, wherein, in the application of the final collision based boundary force to the respective particles, the impulse boundary force is calculated by taking scaling factors with respect to the perpendicular direction and tangential direction that are used in Monaghan boundary force and the tangential friction force into consideration.
